(19) United States
(12) Patent Application Publication
(10) Pub. No.: US 2013/0100634 A1
(43) Pub. Date: Apr. 25, 2013

(54) ELECTRIC POWER SUPPLY

(71) Applicant: DENSO CORPORATION, Kariya-city (JP)

(72) Inventors: Takuya OKUBO, Kariya-shi (JP); Tsuyoshi YAMASHITA, Anjo-shi (JP)

(73) Assignee: DENSO CORPORATION, Kariya-city (JP)

(21) Appl. No.: 13/654,528

(22) Filed: Oct. 18, 2012

(30) Foreign Application Priority Data
Oct. 21, 2011 (JP) 2011-231656

(51) Int. Cl. H01F 27/36

(52) U.S. Cl. 361/816

(57) ABSTRACT

An electric power supply includes: a first board on which at least switching elements Q1 to Q3 (semiconductor elements) are disposed; a transformer; a filter device (a filter section and an output stabilizing section) that reduces alternating current components; and a case that houses therein the first board, the transformer, and the filter device. A first shielding section that blocks noise including leakage magnetic flux from the transformer is provided between the transformer and the filter device that are disposed near each other. As a result of the configuration, the first shielding section is interposed between the transformer and the filter device. Therefore, the effects of noise including leakage magnetic flux from the transformer on the filter device are reduced. Unlike in conventional technologies, an expensive heat sink is not required to be used. Therefore, cost can be reduced from that in the past.

### CROSS-REFERENCE TO RELATED APPLICATION

This application is based on and claims the benefit of priority from earlier Japanese Patent Application No. 2011-231656 filed Oct. 21, 2011, the description of which is incorporated herein by reference.

### BACKGROUND OF THE INVENTION

1. Field of the Invention

The present invention relates to an electric power supply having an electro-magnetic interference (EMI) reduction structure capable of achieving reduced size and reduced cost.

2. Related Art

JP-A-2003-125584, for example, discloses a switching power source having an EMI reduction structure that is capable of reduced size and reduced cost. In the switching power source, a heat sink is connected to a line at a stable potential of a primary circuit of a transformer and interposed therein. As a result, a choke coil with a gap in a power factor improving circuit is not easily affected by leakage magnetic flux from choke coils of a filter circuit and the transformer.

However, the choke coils shown in FIG. 2 of JP-A-2003-125584 are not shielded by the heat sink or the like. In addition, only an electrolytic capacitor is disposed between the choke coils and a transformer for a control circuit. Therefore, the choke coils are easily affected by leakage magnetic flux from the transformer and the transformer for a control circuit. In addition, a choke coil shown in FIG. 3 of JP-A-2003-125584 is disposed almost adjacent to the transformer. Therefore, the choke coil tends to be significantly affected by leakage magnetic flux from the transformer.

To reduce the effects of leakage magnetic flux from the transformer, the transformer for a control circuit, and the like on the choke coils of the filter circuit and the choke coil of a secondary circuit, described above, shielding each choke coil itself with the heat sink can be considered. However, this configuration requires a separate heat sink for each choke coil. Therefore, a problem arises in that cost becomes high.

### SUMMARY

Hence it is desired to provide an electric power supply capable of supplying power to an external device with reduced effects of leakage magnetic flux from a transformer compared to that in the past, while reducing cost from that in the past.

An electric power supply of an exemplary embodiment includes a first board on which at least a semiconductor element is disposed; a transformer; a filter device that reduces alternating current components; and a case that houses therein the first board, the transformer, and the filter device. In the electric power supply, a first shielding section that blocks leakage magnetic flux from the transformer is provided between the transformer and the filter device that are disposed near each other. According to the configuration, the first shielding section is interposed such as to separate the transformer and the filter device. Therefore, the effects of leakage magnetic flux from the transformer on the filter device are reduced. The structure, material, and the like of the first shielding section are arbitrary, as long as the magnetic flux can be blocked. Therefore, unlike in conventional technologies, an expensive heat sink is not required to be used. As a result, power can be supplied to an external device with reduced (or blocked) effects of leakage magnetic flux from the transformer compared to that in the past, while reducing cost from that in the past.

### BRIEF DESCRIPTION OF THE DRAWINGS

FIG. 1 shows an exploded perspective view schematically showing a first configuration example of an electric power supply;

FIG. 2A shows a planar view and FIG. 2B is a side view schematically showing the first configuration example of the electric power supply;

FIG. 3 shows a planar view schematically showing a state in which housed components and the like are housed within a case;

FIG. 4A to FIG. 4D show diagrams of a state in which slits or through holes are formed in a shielding section through which a connecting wire passes;

FIG. 5 shows a cross-sectional view taken along line V-V′ shown in FIG. 3;

FIG. 6 shows a circuit diagram schematically showing a circuit configuration example of the electric power supply;

FIG. 7 shows a side view schematically showing a second configuration example of the electric power supply; and

FIG. 8 shows a perspective view of a second configuration example of a transformer.

### DETAILED DESCRIPTION OF THE PREFERRED EMBODIMENTS

An embodiment for carrying out the present invention will hereinafter be described with reference to the drawings. “Connect” herein refers to electrical connection unless stated otherwise. The drawings show elements required for describing the present invention and do not show all of the actual elements. Directions, such as up, down, right, and left, are used with reference to the drawings. Consecutive reference numbers are expressed using the symbol “−” For example, “connecting wires J1-J8” refers to “connecting wires J1, J2, J3, J4, J5, J6, J7, and J8”. “Noise” is not limited to noise attributed to leakage magnetic flux from a transformer 13 (18), but also includes noise from semiconductors, coils, and the like, as well as external noise.

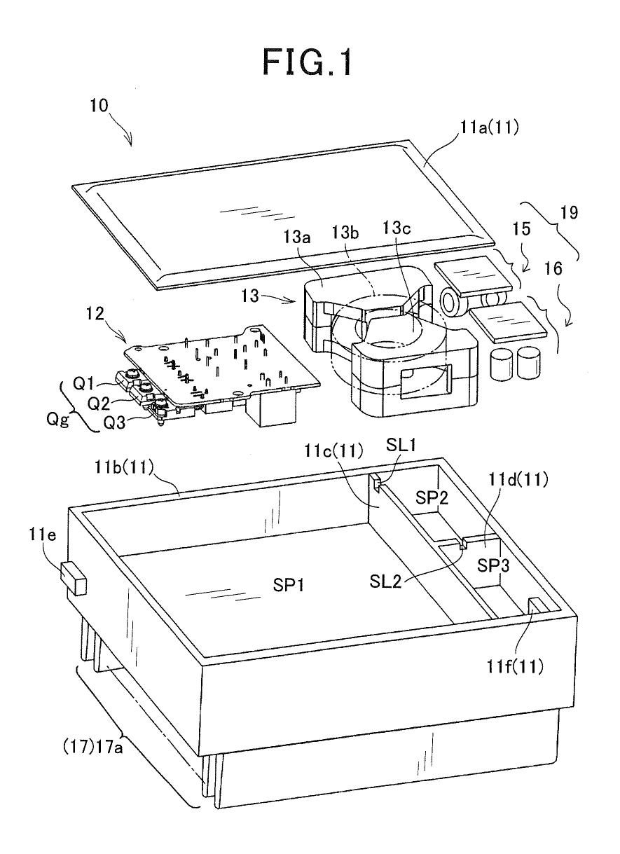

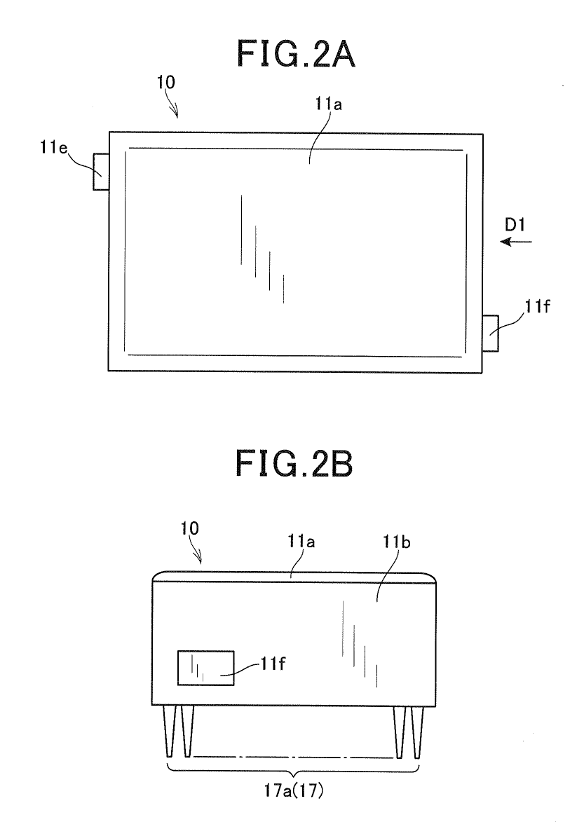

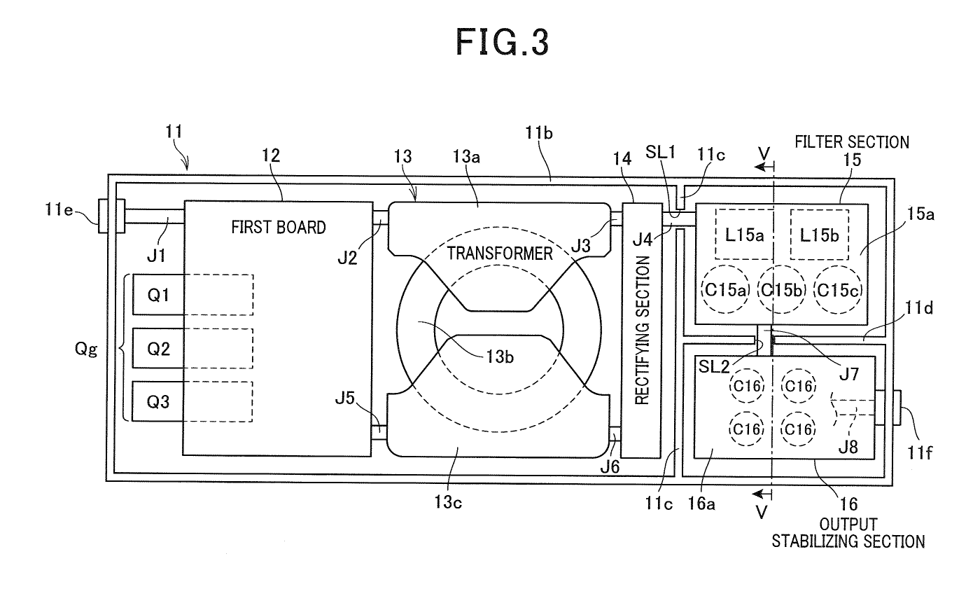

First, a configuration example of an electric power supply will be described with reference to FIG. 1 to FIG. 3. FIG. 1 is an exploded perspective view schematically showing the configuration example of the electric power supply. In the interest of space, a rectifying section is omitted from the drawing. FIG. 2A is a planar view of the electric power supply. FIG. 2B is a right-side view of the electric power supply viewed from the direction of arrow D1 in FIG. 2A. FIG. 3 is a planar view schematically showing an example in which housed components and the like are housed within a case.

An electric power supply 10 described according to the present embodiment is a so-called “direct current-to-direct current (DC-DC) converter”. The electric power supply 10 converts direct current voltage supplied from a power source (such as a battery or a fuel cell) to a target voltage and outputs the converted voltage. The electric power supply 10 has a cooling section 17 provided within a case 11 (configured by a case cover 11a and a case body 11b). A first board 12, a transformer 13, a rectifying section 14, a filter section 15, an output stabilizing section 16, and the like are provided within the case body 11b, as shown in FIG. 3. The filter section 15 and the output stabilizing section 16 are equivalent to a “filter device 19”.

The case body 11b is a box-shaped housing that is open on one face. FIG. 1 shows an example in which the case body 11b is formed into a rectangular parallelepiped shape for simplicity. However, the shape that is formed is arbitrary, as long as the case body 11b is capable of housing the first board 12, the transformer 13, and the like. The case cover 11a is a cover that covers the opening portion of the case body 11b. The case 11 according to the present embodiment is composed of metal. However, the overall case 11 or a portion thereof may be formed using another material (such as resin) satisfying usage environment conditions (such as temperature, electromagnetic shield, and rigidity).

The case body 11b has a plurality of shielding sections as shown in FIG. 1, FIG. 2A, and FIG. 2B. The shielding sections form a plurality of housing sections. In the configuration example in FIG. 1, the case body 11b has a first shielding section 11c and a second shielding section 11d. Housing sections SP1-SP3 are partitioned by the first shielding section 11c and the second shielding section 11d.

FIG. 3 shows a state in which the above-described components are housed in the housing sections SP1-SP3 of the case body 11b. In the configuration example in FIG. 3, the first board 12, the transformer 13, the rectifying section 14, and the filter device 19 are arranged in a single row in order from the left side of the drawing. However, the filter device 19 is disposed such as to be divided in the up/down direction in the drawing into the filter section 15 and the output stabilizing section 16. Specifically, the first board 12, the transformer 13, the rectifying section 14, and the like are disposed in the housing section SP1. The filter section 15 and the like are disposed in the housing section SP2. The output stabilizing section 16 and the like are disposed in the housing section SP3.

The first shielding section 11c is disposed such as to be interposed between the rectifying section 14 and the filter device 19 (in other words, the filter section 15 and the output stabilizing section 16). The second shielding section 11d is disposed such as to be interposed between the filter section 15 and the output stabilizing section 16. In the configuration example according to the present embodiment, the first shielding section 11c and the second shielding section 11d are integrally molded with the case body 11b by casting, injection molding, or the like to be perpendicular to the interior (bottom surface and side surface) of the case body 11b and to stand upright.

The first shielding section 11c, the second shielding section 11d, and other third and fourth shielding sections described hereafter block noise (primarily noise attributed to leakage magnetic flux from the transformer 13). The shape, thickness, material, and the like are arbitrary, as long as an electromagnetic shielding material capable of reducing or blocking the effects of noise is used. For example, a metal plate (including sheet metal), a metal mesh, or foamed metal may be used. Moreover, a resin material formed into a predetermined shape (such as a plate shape or a box shape) may be plated on the front surface and the back surface with metallic ink or a similar substance. Specific configuration examples of the first shielding section 11c and the second shielding section 11d will be described hereafter.

The sizes of the housing sections SP1-SP3 shown in FIG. 1 are merely examples. The size of each housing section SP1-SP3 can be arbitrarily designed depending on, for example, the sizes and the quantities of the boards, circuit elements, and the like housed therein.

Next, the components (housed components) housed in the housing sections (SP1-SP3) of the electric power supply 10 will be described with reference to the drawings. The first board 12 is a so-called printed circuit board (having any number of layers). Elements (including, for example, a group of semiconductor elements Qg and circuit elements), components (including, for example, connecting wires, a base, and terminal bases), and the like (collectively referred to as “mounted components”) are mounted in required positions on the first board 12. Here, the “mounted components” refer to parts capable of being mounted on a printed circuit board, regardless of whether or not they are surface mounted components. The group of semiconductor elements Qg can be composed of any number of elements. However, according to the present embodiment, the group of semiconductor elements Qg is composed of switching elements Q1-Q3.

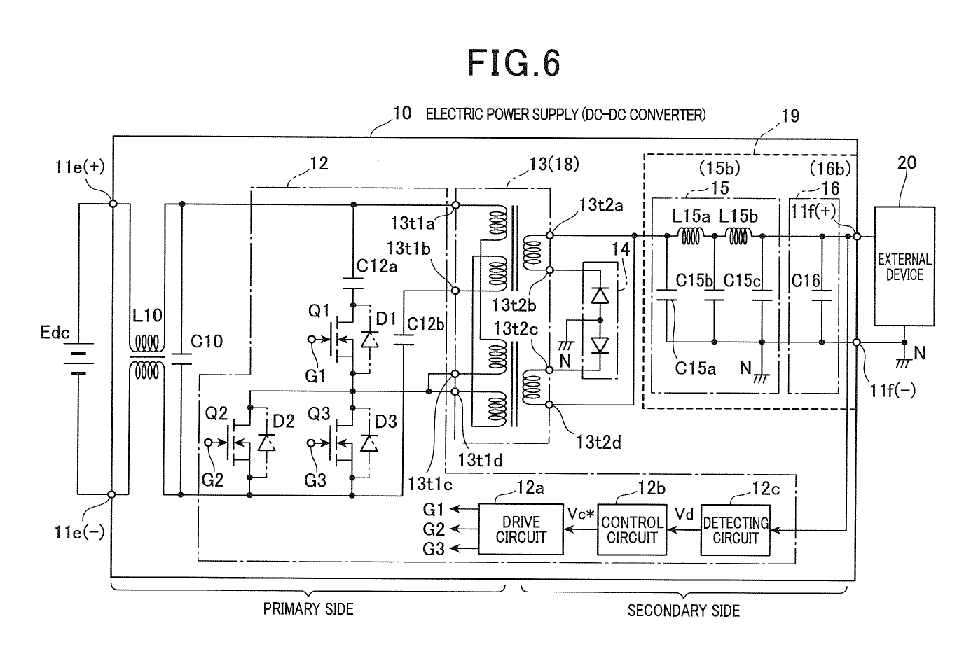

The transformer 13 is disposed such as to be interposed between the first board 12 and the rectifying section 14, as shown in FIG. 3. The transformer 13 has a first core section 13a, a coil 13b, a second core section 13c, and the like. FIG. 6 is a circuit diagram schematically showing a circuit configuration example of the electric power supply 10. As shown in FIG. 6, the transformer 13 has primary terminals 13t1a, 13t1b, 13t1c, and 13t1d, and secondary terminals 13t2a, 13t2b, 13t2c, and 13t2d. The rectifying section 14 converts alternating current power to direct current power. The rectifying section 14 can be configured by, for example, a rectifier circuit and a rectifier.

The filter section 15 configures a portion of the filter device 19. The filter section 15 reduces (or removes) the alternating current components included in the direct current power (particularly direct current voltage; the same applies hereafter) rectified by the rectifying section 14. The filter section 15 can be configured by, for example, a passive filter (such as an LC circuit or an RLC circuit) or an active filter. According to the present embodiment, the filter section 15 is configured by an LC circuit (see FIG. 6). The LC circuit is mounted on a second board 15a, details of which are described hereafter (see FIG. 5).

The output stabilizing section 16 configures a portion of the filter device 19. The output stabilizing section 16 stabilizes and outputs the direct current power of which the alternating current components have been reduced by the filter section 15. Specifically, the voltage ripples in some instances. Therefore, the output stabilizing section 16 is configured using a capacitor (or a group of capacitors; the same applies hereafter) for suppressing the ripples. The capacitor is mounted on a third board 16a, details of which are described hereafter (see FIG. 5).

The cooling section 17 provides a function for cooling the housed components housed within the case 11. According to the present embodiment, cooling fins 17a (radiator fins) are applied as the cooling section 17. The cooling fins 17a are integrally formed on the lower back surface side of the case body 11b, as shown in FIG. 1 and FIG. 2.

As shown in FIG. 3, the case body 11b of the electric power supply 10 includes an input connector lie including input terminals (11e (+) and 11e (−)) into which external direct current power is inputted. A connecting wire 31 is used to connect between the input connector lie and the first board 12. Connecting wires 32 and J5 are used to connect between the first board 12 and the transformer 13. Connecting wires 33 and J6 are used to connect between the transformer 13 and the rectifying section 14. A connecting wire J4 is used to connect between the rectifying section 14 and the filter section 15. A connecting wire 37 is used to connect between the filter section 15 and the output stabilizing section 16. A connecting wire J8 is used to connect between the output stabilizing section 16 and an output connector 11f. The output connector 11f is equivalent to an “output terminal”. Bus bars may be used as the connecting wires 31-38. Alternatively, shielded wires or other conductive wires may be used. For example, when the terminal of the output connector 11f is the connecting wire 38 (such as a bus bar), the connecting wire 38 may be formed as a part of the output connector 11f. The output connector 11f is disposed such that the path of a current flowing from the filter section 15 to the output stabilizing section 16 (connecting wire J7) and the path of a current flowing from the output stabilizing section 16 to the output connector 11f interest (in particular, are perpendicular).

The first shielding section 11c is disposed between the transformer 13 and the filter device 19. As a result of the first shielding section 11c being disposed as such, noise including leakage magnetic flux of the transformer 13 can be prevented from affecting the operation of the filter device 19. Specifically, noise can be prevented from being superimposed on the output power outputted from the output connector 11f.

In addition, the second shielding section 11d is disposed between the filter section 15 and the output stabilizing section 16 configuring the filter device 19. As a result of the second shielding section 11d being disposed as such, noise including leakage magnetic flux of a coil included in the filter section 15 can be prevented from affecting the operation of the output stabilizing section 16. Specifically, noise can be prevented with certainty from being superimposed on the output power outputted from the output connector 11f.

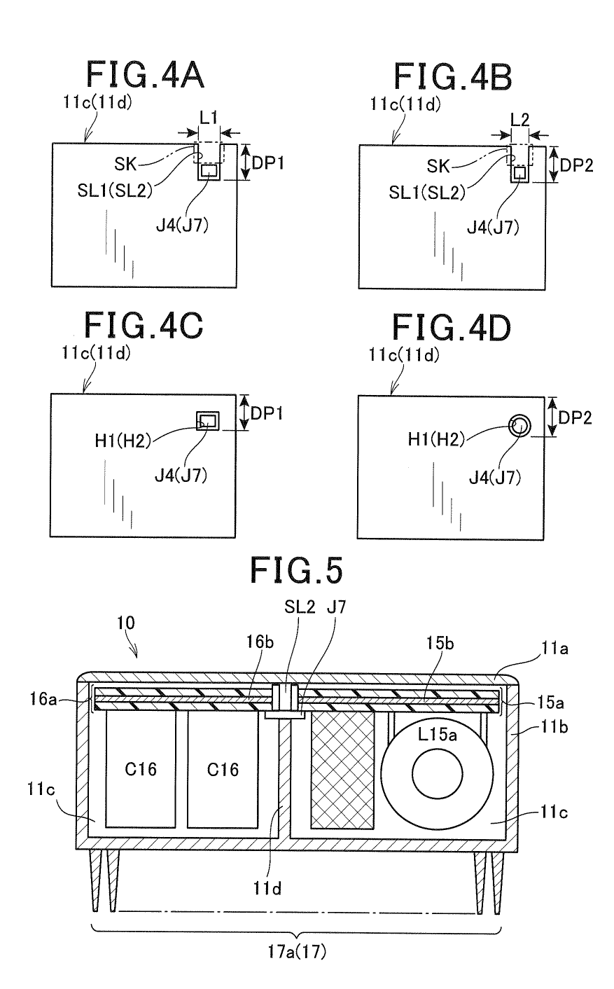

When the electric power supply 10 performs power processing, the connecting wire J4 is required to pass through the first shielding section 11c. The connecting wire 37 is required to pass through the second shielding section 11d. Examples specifying this configuration are shown in FIG. 4A to FIG. 4D. FIG. 4A, FIG. 4B, and FIG. 4C are examples in which a bus bar is used as the connecting wire 34 (J7). FIG. 4D is an example in which a shielded wire is used as the connecting wire 34 (J7). In addition, FIG. 4A and FIG. 4B are examples in which slits are formed. FIG. 4C and FIG. 4D are examples in which through holes are formed. The slits or through holes are formed in a portion of each shielding section.

Slits SL1 is formed to allow the connecting wire 34 to pass and SL2 is formed to allow the connecting wire 37 to pass. The slit SL1 (SL2) shown in FIG. 4A and FIG. 4B differ in slit width L1 (L2) (where L1>L2) and slit depth DP1 (DP2) (where DP1<DP2) depending on how the bus bar is disposed. In other words, when wiring is performed using the bus bar, a wide arrangement such as that in FIG. 4A or an elongated arrangement such as that in FIG. 4B is used. The slits SL1 and SL2 are formed in adherence to the arrangement of the bus bars. In this instance, the slits SL1 and SL2 are preferably disposed in a position near the end portion (the inner wall surface of the case body 11b as shown in FIG. 1 and FIG. 3) of the case 11. In addition, a gap in the upper portions of the slits SL1 and SL2 is preferably shielded by being covered by a shielding material SK (specifically, a shielding material formed into a clip shape or the like), such as aluminum foil.

On the other hand, through holes H1 and H2 are respectively formed to allow the connecting wires J4 and 37 to pass. The through holes H1 and H2 shown in FIG. 4C and FIG. 4D differ in depth DP1 and DP2 depending on the arrangement of the bus bars. FIG. 4C shows an example in which the through holes H1 and H2 are formed with the same depth DP1 as that in FIG. 4A. FIG. 4D shows an example in which the through holes H1 and H2 are formed with the same depth DP2 as that in FIG. 4B. The connecting wires 34 and J7 respectively pass through the through holes H1 and H2. The through holes H1 and H2 are preferably respectively formed having a smallest diameter allowing the connecting wires 34 and J7 to pass. In other words, the shapes of the through holes H1 and H2 and the cross-sectional shape (in other words, diameter) of the bus bar or the shield wire are preferably almost the same. When a gap is present between the through holes H1 and H2 and the bus bar or the shield wire, the gap is preferably shielded using a shielding member (such as a metal plate or steel wool).

FIG. 5 shows a cross-sectional view taken along line V-V′ in FIG. 3. The second board 15a and the third board 16a are printed circuit boards having a plurality of layers (a three-layer structure in FIG. 5). Both boards are disposed in a position near the case cover 11a. A plurality of layers refers to two layers or more. The second board 15a has a ground layer 15b in addition to an arrangement layer (surface layer or back layer) on which circuit elements, components, and the like are arranged. The ground layer 15b is at least a single layer other than the arrangement layer and blocks noise on almost the overall surface of the board. In the configuration examples in FIG. 3 and FIG. 5, coils L15a and L15b, capacitors C15a, C15b, and C15c, and the like are disposed on the arrangement layer. The capacitors C15a, C15b, and C15c can be any type as long as they are each capable of storing capacitance. For example, a plastic film capacitor, a ceramic capacitor, a mica capacitor, an electrolytic capacitor, or an electric double layer capacitor may be used.

In a manner similar to the second board 15a, the third board 16a has at least a single ground layer 16b in addition to an arrangement layer (surface layer or back layer) on which circuit elements, components, and the like are arranged. The ground layer 16b is at least a single layer other than the arrangement layer and blocks noise on almost the overall surface of the board. In the configuration examples in FIG. 3 and FIG. 5, a plurality of capacitors 16 that are connected in parallel and the like are disposed on the arrangement layer.

A circuit diagram of the electric power supply 10 configured as described above is as shown in FIG. 6. However, the circuit diagram shown in FIG. 6 is merely an example showing main sections.

The above-described ground layers 15b and 16b are each formed by a foil-shaped or plate-shaped metal member. Each is connected to a ground N. As a result of the configuration and the connection, the ground layers 15b and 16b are at the same potential as the ground N. Therefore, power can be supplied to the external device 20 with reduced effects of noise passing through the first shielding section 11c.

Next, operations of the electric power supply 10 will be described with reference to FIG. 6. In FIG. 6, an external power source Edc supplies direct current power to the electric power supply 10. For example, a battery or a fuel cell is used as the power source Edc. The input connector lie (+terminal) connected to the plus terminal of the power source Edc is connected to the primary terminal 13t1a of the transformer 13 by way of a choke coil L10 and a capacitor C10. On the other hand, the input connector 11e (− terminal) connected to the minus terminal of the power source Edc is connected to the primary terminal 13t1b of the transformer 13 by way of the choke coil L10 and a capacitor C12b. The choke coil L10 functions as an input filter. The capacitor C10 repeatedly performs charge and discharge of the direct current power.

The first board 12 includes switching elements Q1-Q3, diodes D1-D3, capacitors C10, C12a, C12b, a drive circuit 12a, a control circuit 12b, a detecting circuit 12c, and the like. The switching of the switching elements Q1-Q3 is individually controlled in adherence to corresponding drive signals G1-G3 transmitted from the drive circuit 12a. The detecting circuit 12c detects the output voltage (in other to words, voltage Vd) of the output connector 11f (+ terminal). The control circuit 12b outputs a command signal Vc* that drives the drive circuit 12a such that the voltage Vd becomes a target voltage. The target voltage is recorded in advance in a storage medium within the control circuit 12b or is inputted from an external device (such as an electronic control unit [ECU]). The drive circuit 12a generates the above-described drive signals G1-G3 and outputs the generated drive signals G1-G3 to the corresponding switching element Q1-Q3, based on the command signal Vc*.

The switching element Q1 is connected in series with the switching elements Q2 and Q3. The switching element Q2 and the switching element Q3 are connected in parallel. A connection point of the source terminal of the switching element Q1 and the drain terminals of the switching elements Q2 and Q3 is connected to the primary terminals 13t1c and 13t1d of the transformer 13. The diodes D1-D3, indicated by two-dot chain lines, function as freewheeling diodes. The diodes D1-D3 may be included within the corresponding switching elements Q1-Q3 or may be connected externally. The capacitor C10 is connected between a terminal on one side of the capacitor C12a and the primary terminal 13t1a of the transformer 13, and the source terminals of the switching elements Q2 and Q3 and a terminal on the other side of the capacitor C12b. A terminal on one side of the capacitor C12b is connected to the primary terminal 13t1b of the transformer 13. The capacitor C12a is connected between a terminal on one side of the capacitor C10 and the primary terminal 13t1a of the transformer 13, and the drain terminal of the switching element Q1. The respective terminals on the other side of the capacitor C10 and the capacitor C12 are commonly connected to the source terminals of the switching elements Q2 and Q3.

The secondary terminal 13t2a and the secondary terminal 13t2d of the transformer 13 merge and are connected (directly connected). The filter device 19 (in other words, the filter section 15, the output stabilizing section 16, and the like) is connected between the merging connection point and the output connector 11f (+ terminal). The filter section 15 provides a function for removing high frequency components in the output power. The filter section 15 has coils L15a and 15b, capacitors C15a, C15b, C15c, and the like. Specifically, the coils 115a and L15b are connected in series between the merging connection point and the output connector 11f (+ terminal). The capacitor 15a is connected between the connection point of the merging connection point and the coil L15, and the ground N and the output connector 11f (− terminal). The capacitor C15b is connected between the connection point of the coil L15a and the coil L15b, and the ground N and the output connector 11f (− terminal). The capacitor C15c is connected between the connection point of the coil L15b and the output connector 11f (+ terminal), and the ground N and the output connector 11f (− terminal).

The output stabilizing section 16 functions to suppress ripples in power (particularly voltage) accompanying rectification by the rectifying section 14, described hereafter. The output stabilizing section 16 has a single capacitor C16 or a capacitor C16 in which a plurality of separate capacitors are connected in parallel, and the like. The capacitor C16 is connected to the output connector 11f (in other words, between the + terminal and the − terminal). The external device 20 is connected to the output connector 11f. An arbitrary device requiring power can be applied as the external device 20. For example, the external device 20 is a control device (an ECU, a computer, or the like), a rotating electrical machine (an electric motor, a generator, a motor generator, or the like), or a system (including a power system). In this regard, since capacitor C15c and C16 function same part in circuit characteristics, capacitor C15c is not always required.

The rectifying section 14 is connected between the secondary terminal 13t2b and the secondary terminal 13t2c of the transformer 13. The rectifying section 14 functions to rectify the alternating current power outputted from the transformer 13. FIG. 6 shows a configuration example in which two-phase full-wave rectification is performed. In other words, two diodes are connected in series in opposite directions. The respective anode side terminals of the diodes are commonly connected to the ground N. Single-phase bridge rectification may be performed instead of the two-phase full-wave rectification.

The output power that has been stabilized by the above-described rectifying section 14, the filter section 15, and the output stabilizing section 16 is outputted to the external device 20.

When this power processing is performed, the filter device 19 (the filter section 15 and the output stabilizing section 16) is shielded from noise by the first shielding section 11c, indicated by a thick broken line. The filter section 15 is shielded from noise by the ground layer 15b. The output stabilizing section 16 is shielded from noise by the ground layer 16b. Because a structure is used in which double shielding is performed, power can be supplied to the external device 20 with reduced effects of noise including leakage magnetic flux from the transformer 13, compared to that in the past.

(Effects)

According to the above-described embodiment, the following effects can be achieved.

First, in the electric power supply 10, the first shielding section 11c is included that blocks leakage magnetic flux from the transformer 13 between the transformer 13 and the filter device 19 that are disposed near each other. Therefore, the first shielding section 11c separates the transformer 13 and the filter device 19. As a result, the effects of noise including leakage magnetic flux from the transformer 13 on the filter device 19 can be reduced. The first shielding section 11c can have an arbitrary structure and be composed of a material capable of blocking magnetic flux. Therefore, unlike in conventional technology, an expensive heat sink is not required to be used. Therefore, power can be supplied to the external device 20 with reduced effects of noise including leakage magnetic flux from the transformer 13 compared to that in the past, while reducing cost from that in the past.

In addition, the first shielding section 11c is provided with the slits SL1 and SL2 or the through holes H1 and H2 that allow a connecting member electrically connecting the transformer 13 and the filter device 19 to pass. The slits SL1 and SL2 or the through holes H1 and H2 are disposed in a position near the end portion (the inner wall surface of the case body 11b as shown in FIG. 1 and FIG. 3) of the case 11 (see FIG. 1, FIG. 3, and FIG. 4). Therefore, leakage of noise including leakage magnetic flux from the transformer 13 can be significantly reduced.

The filter device 19 is configured by the filter section 15 that reduces alternating current components and the output stabilizing section 16 that stabilizes output power. The second shielding section 11d that blocks leakage magnetic flux is provided between the filter section 15 and the outputs stabilizing section 16 (see FIG. 1, FIG. 3, and FIG. 6). Therefore, the effects of noise including leakage magnetic flux from the coils L15a and L15b and an inductor included in the filter section 15 on the output stabilizing section 16 can be reduced.

In addition, the output connector 11f (output terminal) that outputs power to the external device 20 is provided. When the output connector 11f is disposed such that the path of the current flowing from the filter section 15 to the output stabilizing section 16 (connecting wire J7) and the path of the current flowing from the output stabilizing section 16 to the output connector 11f (connecting wire 38) intersect (see FIG. 3), the position of the output connector 11f can be set taking into consideration linearity and diffraction of the magnetic flux. Therefore, noise including the leakage magnetic flux from the transformer 13 directly affecting the output stabilizing section 16 can be reduced.

In addition, the case 11 is configured by the box-shaped case body 11b that is open on one face, and the cover 11b that covers the opening. The third shielding section (the ground layer 15b of the second board 15a) that blocks leakage magnetic flux is provided on the cover side of the filter device 19 (see FIG. 3 and FIG. 5). Therefore, power can be supplied to the external device 20 with the effects of noise including leakage magnetic flux passing through the first shielding section 11c being reduced by the ground layer 15b.

The third shielding section is configured by a plurality of layers. The second board 15a connected to the ground N (see FIG. 3 and FIG. 6) is used as at least one layer (ground layer 15b) among the plurality of layers. Therefore, the second board 15a functions both as the filter section 15 and the third shielding section. In other words, the filter section 15 and the third shielding section can be actualized by the second board 15a. Therefore, overall cost of the device can be reduced.

In addition, the output connector 11f includes the connecting wire J8 composed of a bus bar and includes the fourth shielding section (the ground layer 16b of the third board 16a) that blocks leakage magnetic flux on the case cover side of the bus bar (see FIG. 3 and FIG. 5). Therefore, power can be supplied to the external device 20 with the effects of noise including leakage magnetic flux passing through the first shielding section 11 being reduced by the ground layer 16b.

In addition, the fourth shielding section is configured such that the third board 16a connected to the ground N (see FIG. 3 and FIG. 5) is used as the ground layer 16b (at least one layer). As a result of this configuration, the third board 16a composed of a plurality of layers can function both as the filter section 15 and the fourth shielding section. In other words, the filter section 15 and the fourth shielding section can be actualized by the third board 16a. Therefore, the overall cost of the device can be reduced.

### Other Embodiments

An embodiment for carrying out the present invention has been described in detail above. However, the present invention is not limited in any way thereto. Various modifications can be made without departing from the scope of claims. For example, the following embodiments are possible.

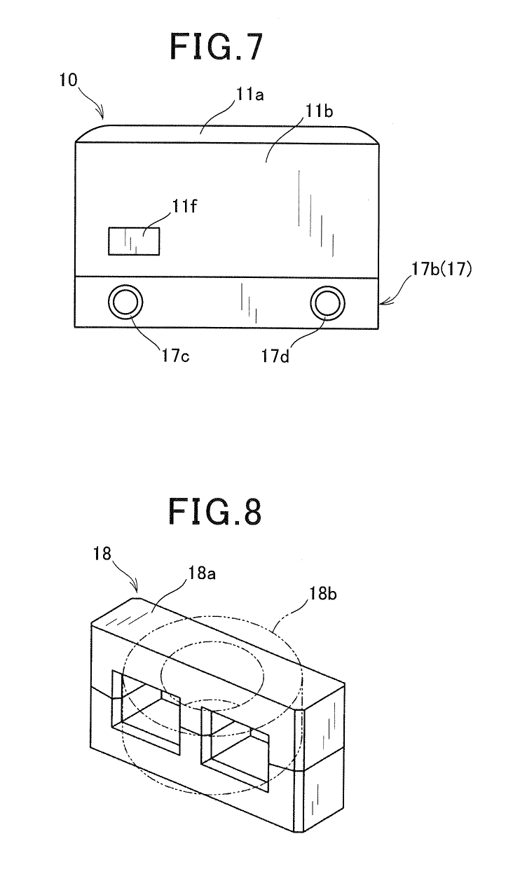

According to the above-described embodiment, the cooling section 17 is configured to include the cooling fins 17a (see FIG. 1, FIG. 2, and FIG. 5). However, instead (or in addition), other cooling measures may be used. Other cooling measures are at least one of a water-cooled mechanism 17b shown in FIG. 7, a heat pump, and the like. The water-cooled mechanism 17b includes an inlet pipe 17c and an outlet pipe 17d serving as an inlet and an outlet for allowing a coolant (such as water, air, or oil) to flow. The arrangements of the inlet pipe 17c and the outlet pipe 17d are arbitrary and not limited to the arrangement example in FIG. 7. The inlet pipe 17c and the outlet pipe 17d are physically connected by a tube-shaped member (such as a hose or a pipe). A coolant flows between the electric power supply 10 and a cooling device (such as a radiator; not shown). The water-cooled mechanism 17b preferably forms a coolant path such that circuit elements (such as the group of semiconductor elements Qg and the rectifying section 14) that easily generate heat are cooled. The group of semiconductor elements Qg and mounted components can be cooled even when other cooling measures are used. Therefore, effects similar to those according to the above-described embodiment can be achieved.

According to the above-described embodiment, the case 11 is configured such that the case body 11 and the cooling section 17 (in other words, the cooling fins 17a or the water-cooled mechanism 17b) are integrally formed (see FIG. 1, FIG. 2, and FIG. 5). Instead, the cooling section 17 may be formed separately and then fixed to the case body 11b. The fixing measures are arbitrary. For example, cooling section 17 can be fixed by being fastened using a fastening member such as a screw or a bolt. Alternatively, the cooling section 17 can be connected by welding, soldering, or the like. In this configuration as well, the case body 11b can be cooled by the cooling section 17. Therefore, effects similar to those according to the above-described embodiment can be achieved.

According to the above-described embodiment, a transformer 13 is applied that includes the first core section 13a, the coil 13b, and the second core section 13c (see FIG. 1 and FIG. 3). Instead, a transformer 18 (a so-called E-type transformer) shown in FIG. 8 may be applied. The transformer 18 shown in FIG. 8 is configured by a core section 18a, a coil 18b, and the like. The core section 18a is formed by a core upper portion and a core lower portion being placed such as to oppose each other and fixed. When an opening portion (also referred to as a “window face”) of the core section 18a is disposed such as to face the up/down direction in FIG. 3, the effects on the filter device 19 (in other words, the filter section 15 and the output stabilizing section 16) can be reduced. Therefore, effects similar to those according to the above-described embodiment can be achieved.

According to the above-described embodiment, the first shielding section 11c and the second shielding section 11d are molded integrally with the case body 11b (see FIG. 1 and FIG. 3). Instead, at least one of the first shielding section 11c and the second shielding section 11d may be formed separately and then fixed to a predetermined position within the case body 11b. The fixing measures are as described above. When the first shielding section 11c and the second shielding section 11d are integrated into a T-shape and fixed, production steps can be reduced. Both configurations are the same in terms of the case 11 including the first shielding section 11c and the second shielding section 11d. Therefore, effects similar to those according to the above-described embodiment can be achieved.

According to the above-described embodiment, the filter section 15 includes the coils L15a and L15b (see FIG. 3 and FIG. 6). Instead, one or more of the coils L15a and L15b may be replaced with a reactor. Even when the reactor is used, the reactor operates in the same manner as the coil. Therefore, effects similar to those according to the above-described embodiment can be achieved.

According to the above-described embodiment, the filter section 15 includes the capacitor C15a, C15b, and C15c. The output stabilizing section 16 includes the capacitor C16 (see FIG. 3 and FIG. 6). Instead, at least one of the capacitors may be replaced by a capacitor battery. Even when the capacitor battery is used, the capacitor battery operates in the same manner as the capacitor. Therefore, effects similar to those according to the above-described embodiment can be achieved.

According to the above-described embodiment, the third shielding section is actualized by the ground layer 15b of the second board 15a. The fourth shielding section is actualized by the ground layer 16b of the third board 16a (see FIG. 5). Instead, at least one of the ground layers 15b and 16b may be replaced by a shielding section similar to the first shielding section 11c and the second shielding section 11d. Using FIG. 5 as an example, the third shielding section may be formed between the case cover 11a and the second board 15a. The fourth shielding section may be formed between the case cover 11a and the third board 16a. In both configurations, noise passing through the first shielding section 11c can be blocked. Therefore, effects similar to those according to the above-described embodiment can be achieved.

What is claimed is:

1. An electric power supply comprising:
a first board on which at least a semiconductor element is disposed;
a transformer;
a filter device that reduces alternating current components; and
a case that houses therein the first board, the transformer, and the filter device, wherein a first shielding section that blocks leakage magnetic flux from the transformer is provided between the transformer and the filter device that are disposed near each other.

2. The electric power supply according to claim 1, wherein the first shielding section has a slit or a through hole through which a connecting member that electrically connects the transformer and the filter device passes, and the slit or the through hole is disposed in a position near an end portion of the case.

3. The electric power supply according to claim 2, wherein the filter device has a filter section that reduces alternating current components and an output stabilizing section that stabilizes output power, further comprising:
a second shielding section that blocks the leakage magnetic flux is provided between the filter section and the output stabilizing section.

4. The electric power supply according to claim 3, further comprising:
an output terminal that outputs power to an external device, wherein the output terminal is disposed such that a path of current flowing from the filter section to the output stabilizing section and a path of current flowing from the output stabilizing section to the output terminal intersect.

5. The electric power supply according to claim 4, wherein the case has a box-shaped case body that is open on one face and a case cover that covers the opening in the case body, further comprising:
a third shielding section, which blocks the leakage magnetic flux, is provided on the case cover side of the filter device.

6. The electric power supply according to claim 5, wherein the third shielding section is composed of a plurality of layers of which at least one layer is configured by a second board connected to a ground.

7. The electric power supply according to claim 6, wherein the output terminal includes a bus bar, further comprising:
a fourth shielding section, which blocks the leakage magnetic flux, is provided on the case cover side of the bus bar.

8. The electric power supply according to claim 7, wherein the fourth shielding section is composed of a plurality of layers of which at least one layer is configured by a third board connected to a ground.

9. The electric power supply according to claim 1, wherein the filter device has a filter section that reduces alternating current components and an output stabilizing section that stabilizes output power, further comprising:
a second shielding section that blocks the leakage magnetic flux is provided between the filter section and the output stabilizing section.

10. The electric power supply according to claim 1, wherein the case has a box-shaped case body that is open on one face and a case cover that covers the opening in the case body, further comprising:
a third shielding section, which blocks the leakage magnetic flux, is provided on the case cover side of the filter device.

11. The electric power supply according to claim 2, wherein the case has a box-shaped case body that is open on one face and a case cover that covers the opening in the case body, further comprising:
a third shielding section, which blocks the leakage magnetic flux, is provided on the case cover side of the filter device.

12. The electric power supply according to claim 3, wherein the case has a box-shaped case body that is open on one face and a case cover that covers the opening in the case body, further comprising:
a third shielding section, which blocks the leakage magnetic flux, is provided on the case cover side of the filter device.

13. The electric power supply according to claim 4, wherein the output terminal includes a bus bar, further comprising:
a fourth shielding section, which blocks the leakage magnetic flux, is provided on the case cover side of the bus bar.

14. The electric power supply according to claim 5, wherein the output terminal includes a bus bar, further comprising:
a fourth shielding section, which blocks the leakage magnetic flux, is provided on the case cover side of the bus bar.
